(19) United States
(12) Patent Application Publication
(10) Pub. No.: US 2024/0026921 A1
(43) Pub. Date: Jan. 25, 2024

(54) FOIL BEARING

(71) Applicant: KABUSHIKI KAISHA TOYOTA JIDOSHOKKI, Aichi (JP)

(72) Inventors: Fumiya SHINODA, Aichi (JP); Fumihiro SUZUKI, Aichi (JP)

(73) Assignee: KABUSHIKI KAISHA TOYOTA JIDOSHOKKI, Aichi (JP)

(21) Appl. No.: 18/221,611

(22) Filed: Jul. 13, 2023

(30) Foreign Application Priority Data
Jul. 22, 2022 (JP) 2022-117018

(51) Int. Cl. F16C 17/02

(52) U.S. Cl. CPC F16C 17/024

(57) ABSTRACT

A foil bearing includes a bearing housing, a top foil, and a bump foil. The bump foil has: a first portion, a second portion, and a third portion disposed at least between the first portion and the second portion and configured to come in contact with the top foil. The top foil applies a load to the second portion with displacement of the top foil in a radially outward direction of the bearing housing. The third portion is not in contact with the top foil when the load is equal to or lower than a predetermined load, and is in contact with the top foil with elastic deformation of the second portion when the load is higher than the predetermined load. The first portion is in surface contact with the inner peripheral surface.

### CROSS-REFERENCE TO RELATED APPLICATION

This application claims priority to Japanese Patent Application No. 2022-117018 filed on Jul. 22, 2022, the entire disclosure of which is incorporated herein by reference.

The present disclosure relates to a foil bearing that supports a rotary shaft in a radial direction.

### BACKGROUND ART

The foil bearing for supporting the rotary shaft in the radial direction includes a bearing housing, a top foil, and a bump foil. The radial direction corresponds to the radial direction of the rotary shaft. The bearing housing has a cylindrical shape. The rotary shaft is inserted through the bearing housing. The top foil has a thin plate shape. The top foil is arranged between the rotary shaft and the bearing housing. The bump foil has a thin plate shape. The bump foil is disposed between the bearing housing and the top foil to elastically support the top foil. In such a foil bearing, when the rotational speed of the rotary shaft reaches the predetermined rotational speed, a fluid film is formed between the rotary shaft and the top foil. The dynamic pressure of the fluid film allows the rotary shaft to float off the top foil. This allows the foil bearing to support the rotary shaft in the radial direction.

Specifically, the bump foil has a first portion that is in contact with the inner peripheral surface of the bearing housing and a second portion that is in contact with the top foil. The top foil is displaced in the radially outward direction of the bearing housing by the dynamic pressure of the fluid film formed between the rotary shaft and the top foil. The second portion is subjected to a load applied by the top foil with displacement of the top foil in the radially outward direction of the bearing housing. This allows the second portion to become elastically deformed, and therefore allows the bump foil to elastically support the top foil.

The bump foil may be made of a material having high rigidity, for example. This prevents the second portion of the bump foil from becoming elastically deformed when the load applied by the top foil to the second portion is equal to or lower than the predetermined load. This therefore prevents the bump foil from elastically supporting the top foil when the top foil is displaced in the radially outward direction of the bearing housing. This therefore prevents stable supporting of the rotary shaft in the radial direction.

On the other hand, the bump foil may be made of a material having low rigidity, for example. This may cause the second portion of the bump foil to become excessively deformed when the load applied by the top foil to the second portion is higher than the predetermined load. This causes the bump foil to become excessively deformed, thereby preventing stable supporting of the rotary shaft in the radial direction.

Japanese Patent Application Publication No. S58-99515 discloses a bump foil that further has a third portion, which does not come in contact with the top foil when the load applied by the top foil to the second portion of the bump foil is equal to or lower than the predetermined load. In such a bump foil, the third portion is configured to be in contact with the top foil with the elastic deformation of the second portion when the load is higher than the predetermined load. This configuration allows the third portion not to be in contact with the top foil when the load applied by the top foil to the second portion of the bump foil is equal to or lower than the predetermined load, thereby securing the amount of the elastic deformation of the bump foil. This configuration therefore allows the bump foil to elastically support the top foil when the load applied by the top foil to the second portion is equal to or lower than the predetermined load. On the other hand, this configuration causes the third portion to be in contact with the top foil when the load applied by the top foil to the second portion of the bump foil is higher than the predetermined load, thereby increasing the stiffness of the bump foil. This configuration therefore prevents excessive deformation of the bump foil when the load applied by the top foil to the second portion is higher than the predetermined load. Accordingly, this configuration allows the bump foil having the third portion to stably support the rotary shaft in the radial direction.

The first portion has a spring structure if the first portion is curved and has a curvature radius that is smaller than a curvature radius of the inner peripheral surface of the bearing housing. This structure may prevent damping of vibration of the rotary shaft if the bump foil supports the vibrating and displacing rotary shaft and the first portion becomes elastically deformed.

Furthermore, the bump foil may be made of a material that has hardness higher than that of the material for the bearing housing. This may promote wear of the bearing housing if a contact area between the first portion of the bump foil and the inner peripheral surface of the beating housing is small.

The present disclosure, which has been made in light of the above described problem, is directed to providing a foil bearing that facilitates damping of vibration of a rotary shaft and reduces wear of a beating housing while stably supporting the rotary shaft in the radial direction.

### SUMMARY

in accordance with an aspect of the present disclosure, there is provided a foil bearing for supporting a rotary shaft in a radial direction of the rotary shaft. The foil bearing includes: a bearing housing having a cylindrical shape and through which the rotary shaft is inserted; a top foil having a thin plate shape and disposed between the rotary shaft and the bearing housing; and a bump foil having a thin plate shape and made of a material that has hardness higher than hardness of a material for the bearing housing. The bump foil is disposed between the bearing housing and the top foil to elastically support the top foil. The bump foil has: a first portion in contact with an inner peripheral surface of the bearing housing; a second portion in contact with the top foil and configured to become elastically deformed with displacement of the top foil in a radially outward direction of the bearing housing; and a third portion disposed at least between the first portion and the second portion and configured to come in contact with the top foil. The top foil applies a load to the second portion with the displacement of the top foil in the radially outward direction of the bearing housing. The third portion is not in contact with the top foil when the load is equal to or lower than a predetermined load, and is in contact with the top foil with elastic deformation of the second portion when the load is higher than the predetermined load. The first portion is in surface contact with the inner peripheral surface.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a schematic configuration diagram of a centrifugal compressor to which a foil bearing is mounted;

FIG. 2 is a sectional view of the foil bearing;

FIG. 3 is a schematic view of a bump foil;

FIG. 4 is a sectional view of the foil bearing when a load is higher than a predetermined load;

FIG. 5 is a graph showing a relationship between the load and an amount of elastic deformation of the bump foil;

FIG. 6 is a perspective view of a bump foil of a foil bearing according to a modification; and

FIG. 7 is a perspective view of a bump foil of a foil bearing according to a modification.

### DETAILED DESCRIPTION OF THE EMBODIMENTS

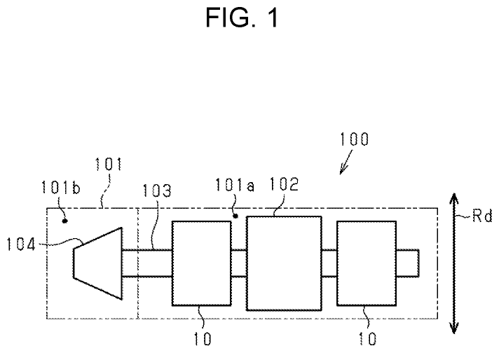

The following will describe an embodiment of a foil bearing with reference to accompanying FIGS. 1 to 5. The foil bearing according to the embodiment is mounted to a centrifugal compressor.

<Centrifugal Compressor>

As illustrated in FIG. 1, a centrifugal compressor 100 includes a plurality of foil bearings 10, a housing 101, an electric motor 102, a rotary shaft 103, and an impeller 104. The electric motor 102, the rotary shaft 103, and the impeller 104 are accommodated in the housing 101. The electric motor 102 is accommodated in a motor chamber 101a in the housing 101. The impeller 104 is accommodated in an impeller chamber 101b in the housing 101. The rotary shaft 103 extends from the motor chamber 101a to the impeller chamber 101b. The rotary shaft 103 is provided with the electric motor 102. The rotary shaft 103 has an end on which the impeller 104 is mounted. The rotary shaft 103 is rotated by the electric motor 102 driven. The rotation of the rotary shaft 103 rotates the impeller 104. The rotation of the impeller 104 draws a fluid from the outside of the housing 101 into the impeller chamber 101b. The fluid drawn into the impeller chamber 101b is compressed with the rotation of the impeller 104. The compressed fluid is discharged from the housing 101.

According to this embodiment, two foil bearings 10 support the rotary shaft 103 in a radial direction Rd. The radial direction Rd corresponds to the radial direction of the rotary shaft 103. The foil bearings 10 are disposed so that the electric motor 102 is disposed between the foil bearings 10 in the axial direction of the rotary shaft 103. The foil bearings 10 are fixed to the housing 101.

<Foil Bearing>

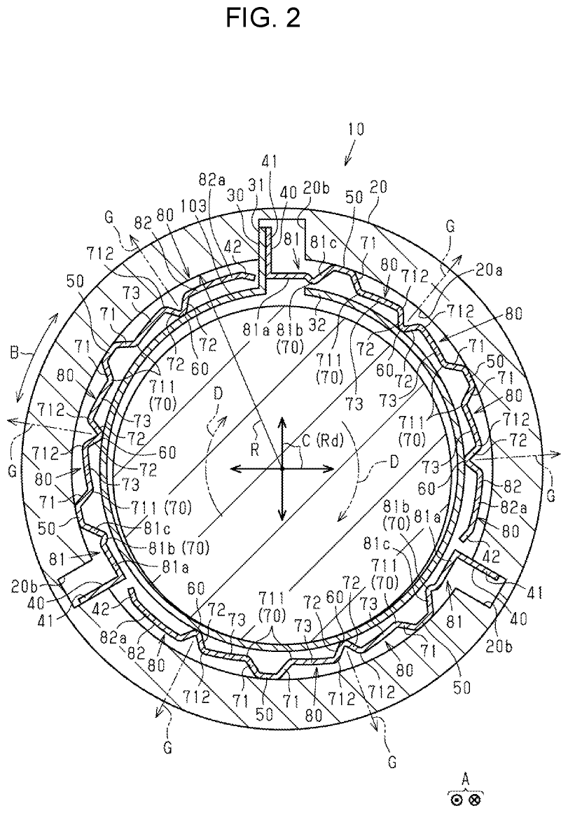

As illustrated in FIG. 2, each foil bearing 10 includes a beating housing having a cylindrical shape, a top foil 30 having a thin plate shape, and a plurality of bump foils 40 having a thin plate shape. FIG. 2 illustrates the foil bearing 10 being in a situation where the rotary shaft 103 is not rotated.

<Bearing Housing>

The rotary shaft 103 is inserted through the bearing housing 20. In the following description, the axial direction, the peripheral direction, and the radial direction of the bearing housing 20 are simply referred to as an axial direction A, a peripheral direction B, and a radial direction C, respectively.

The bearing housing 20 has an inner peripheral surface 20a. The inner peripheral surface 20a is curved in the peripheral direction B. The inner peripheral surface 20a of the bearing housing 20 has a plurality of holding grooves 20b. Specifically, in this embodiment, the inner peripheral surface 20a has three holding grooves 20b. The three holding grooves 20b are spaced from each other at a predetermined distance in the peripheral direction B. Each holding groove 20b extends in the axial direction A. The bearing housing 20 is made of a material, such as aluminum.

<Top Foil>

The top foil 30 is disposed inside the bearing housing 20. The top foil 30 is disposed between the rotary shaft 103 and the bearing housing 20. The top foil 30 is formed of a flexible long metallic plate curved into a cylindrical shape. The top foil 30 has an approximately cylindrical shape. The axial direction of the top foil 30 corresponds to the axial direction A. The peripheral direction of the top foil 30 corresponds to the peripheral direction B. The radial direction of the top foil 30 corresponds to the radial direction C. The top foil 30 is curved into a cylindrical shape such that the long edges and the short edges of the top foil 30 extend in the peripheral direction B and the axial direction A, respectively. The metallic plate forming the top foil 30 is made of nickel alloy, such as stainless steel or Inconel™. That is, the top foil 30 is made of a material that has hardness higher than that of the material for the bearing housing 20.

The top foil 30 has a fixed end 31 and a free end 32. The fixed end 31 is one end of the top foil 30 in the direction of the long sides of the metallic plate forming the top foil 30 and is fold in the radially outward direction of the top foil 30. The fixed end 31 is inserted into one of the holding grooves 20b. The fixed end 31 is fixed to the holding groove 20b, for example, by welding. The free end 32 is the other end of the top foil 30 in the direction of the long sides of the metallic plate forming the top foil 30. The free end 32 faces and is spaced from the proximal portion of the fixed end 31 in the peripheral direction B. Accordingly, the top foil 30 has an incomplete ring shape with a cutout.

<Bump Foil>

In this embodiment, three bump foils 40 are disposed between the bearing housing 20 and the top foil 30. Each bump foil 40 is disposed outward of the top foil 30 in the radial direction C. The bump foils 40 are spaced from each other at a predetermined distance in the peripheral direction B. Each bump foil 40 is thinner than the top foil 30. The bump foil 40 has a uniform thickness.

The bump foil 40 is formed of a flexible long metallic plate curved into an approximately arc shape. The direction of the short sides of the bump foil 40 corresponds to the axial direction A. The metallic plate forming the bump foil 40 is made of nickel alloy, such as stainless steel or Inconel™. The bump foil 40 is made of a material that has hardness higher than that of the material for the bearing housing 20.

The bump foil 40 has a fixed end 41 and a free end 42. The fixed end 41 is one end of the bump foil 40 in the direction of the long sides of the metallic plate forming the bump foil 40. The fixed end 41 of each bump foil 40 is inserted into the corresponding holding groove 20b. One of the fixed ends 41 is inserted together with the fixed end 31 of the top foil 30 into the corresponding holding groove 20b. The fixed end 41 and the fixed end 31 of the top foil 30 inserted together are fixed to the holding groove 20b, for example, by welding. The other two fixed ends 41 are respectively fixed to the other two holding grooves 20b, for example, by welding. The free end 42 is the other end of each bump foil 40 in the direction of the long sides of the metallic plate forming the bump foil 40. The free end 42 of one bump foil 40 is spaced from the fixed end 41 of the adjacent another bump foil 40 at a predetermined distance in the peripheral direction B. The means for fixing the fixed end 31 and the fixed end 41 to the holding groove 20b may be changed as necessary.

Each bump foil 40 has a plurality of first portions 50, a plurality of second portions 60, a plurality of first extending portions 71, a plurality of second extending portions 72, a plurality of third extending portions 73, a first end plate portion 81, and a second end plate portion 82.

In this embodiment, the bump foil 40 has two first portions 50, and the first portions 50 are formed by partly curving the bump foil 40 in the thickness direction of the bump foil 40. The first portions 50 are spaced from each other in the direction of the long sides of the bump foil 40. Specifically, the first portions 50 are spaced from each other at a predetermined distance in the peripheral direction B. The first portions 50 extend along the inner peripheral surface 20a of the bearing housing 20. The first portions 50 are curved and have a curvature radius that is equal to a curvature radius R of the inner peripheral surface 20a of the bearing housing 20. The first portions 50 are in surface contact with the inner peripheral surface 20a of the bearing housing 20. The first portions 50 are curved and have a curvature radius that is equal to the curvature radius R of the inner peripheral surface 20a of the bearing housing 20 with the bump foil 40 placed inside the bearing housing 20.

In this embodiment, the bump foil 40 has two second portions 60, and the second portions 60 are formed by partly curving the bump foil 40 in the thickness direction of the bump foil 40. The second portions 60 and the first portions 50 are alternately arranged in the direction of the long sides of the bump foil 40. The second portions 60 are spaced from each other at a predetermined distance in the peripheral direction B. The second portions 60 are bent and bulge toward the top foil 30. The second portions 60 are in contact with the top foil 30. The contact area between each second portion 60 and the top foil 30 is smaller than the contact area between each first portion 50 and the bearing housing 20.

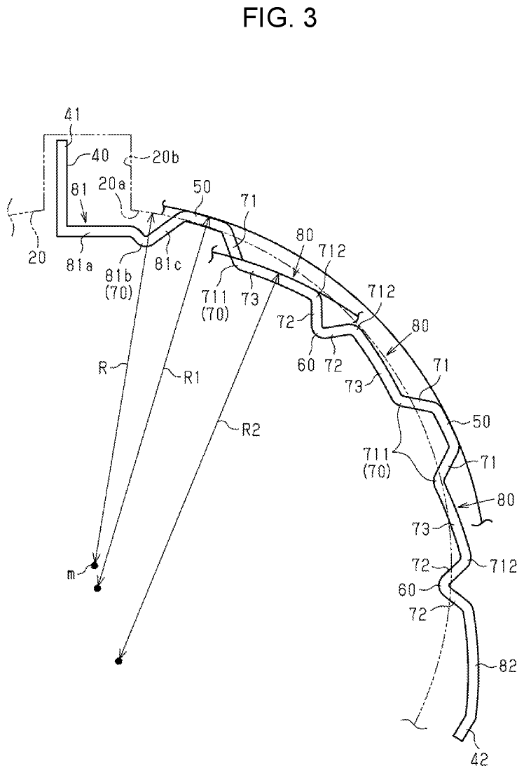

FIG. 3 illustrates the bump foil 40 that is not placed inside the bearing housing 20. In this state, the first portion 50 is curved and has a curvature radius R1 that is larger than the curvature radius R of the inner peripheral surface 20a of the beating housing 20. FIG. 2 illustrates the bump foil 40 that is placed inside the beating housing 20 and is held between the bearing housing and the top foil 30. In this state, the first portion 50 becomes elastically deformed so as to extend along the inner peripheral surface 20a of the bearing housing 20. The curvature radius R1 of the first portion 50 may be equal to the curvature radius R. In this structure, the first portion 50 extends along the inner peripheral surface 20a of the bearing housing 20 without becoming elastically deformed when the bump foil 40 is placed inside the bearing housing 20.

Each first extending portion 71 is continuous to the corresponding first portion 50. The bump foil 40 is bent and bulges toward the bearing housing 20 at the border between the first extending portion 71 and the first portion 50. The angle between the first extending portion 71 and the first portion 50 is an obtuse angle. The first extending portion 71 extends from the first portion 50 toward the top foil 30. The first extending portion 71 does not reach the top foil 30.

Each second extending portion 72 is continuous to the corresponding second portion 60. The second extending portion 72 extends from the second portion 60 toward the bearing housing 20. The second extending portion 72 does not reach the bearing housing 20.

Each third extending portion 73 extends between the first extending portion 71 and the second extending portion 72. The third extending portion 73 is continuous to the corresponding first extending portion 71. The angle between the first extending portion 71 and the third extending portion 73 is an obtuse angle. A first bending portion 711 is formed at the border between the first extending portion 71 and the third extending portion 73, and the first bending portion 711 is bent and bulges toward the top foil 30. The third extending portion 73 cooperates with the first extending portion 71 to form the first bending portion 711. The first bending portion 711 is disposed between the first portion 50 and the second portion 60. The first bending portion 711 has a spring structure that has an elastic force generated when the first extending portion 71 and the third extending portion 73 move closer to or move away from each other. The first bending portion 711 is not in contact with the top foil 30 when the rotary shaft 103 is not rotating.

The third extending portion 73 is continuous to the corresponding second extending portion 72. The angle between the second extending portion 72 and the third extending portion 73 is an obtuse angle. A second bending portion 712 is formed at the border between the second extending portion 72 and the third extending portion 73, and the second bending portion 712 is bent and bulges toward the bearing housing 20. The third extending portion 73 cooperates with the second extending portion 72 to form the second bending portion 712. The second bending portion 712 has a spring structure that has an elastic force generated when the second extending portion 72 and the third extending portion 73 move closer to or move away from each other. The third extending portion 73 and the second bending portion 712 are disposed between the first portion 50 and the second portion 60. The second bending portion 712 is not in contact with the bearing housing 20 when the rotary shaft 103 is not rotating. Accordingly, the bump foil 40 is disposed between the bearing housing and the top foil 30 to elastically support the top foil 30 with the elastic force of each of the second portion 60, the first bending portion 711, and the second bending portion 712.

The second bending portion 712 is closer to the inner peripheral surface of the bearing housing 20 than the first bending portion 711 is. The first bending portion 711 is closer to the top foil 30 than the second bending portion 712 is. That is, when the rotary shaft 103 is not rotating, the third extending portion 73 extends from the first bending portion 711 to the second bending portion 712 in the peripheral direction B such that the third extending portion 73 gradually approaches the inner peripheral surface 20a of the bearing housing 20.

As illustrated in FIGS. 2 and 3, when the rotary shaft 103 is not rotating, the third extending portion 73 is curved and bulges toward the bearing housing 20. The third extending portion 73 is curved and has a curvature radius R2 that is larger than the curvature radius R of the inner peripheral surface 20a of the bearing housing 20. The curvature radius R2 of the third extending portion 73 may be equal to the curvature radius R when the rotary shaft 103 is not rotating. That is, the third extending portion 73 needs to be curved such that the third extending portion 73 has the curvature radius R2 that is equal to or larger than the curvature radius R when the rotary shaft 103 is not rotating.

The first end plate portion 81 of the bump foil 40 is disposed between the proximal portion of the fixed end 41 and the first portion 50. The first end plate portion 81 is continuous to the proximal portion of the fixed end 41 of the bump foil 40. The first end plate portion 81 is continuous to the first portion 50. The first end plate portion 81 has a first plate portion 81a, a second plate portion 81b, and a third plate portion 81c. The first plate portion 81a extends from the proximal portion of the fixed end 41 of the bump foil 40 and through a gap between the beating housing 20 and the top foil 30. The second plate portion 81b is formed by partly bending the bump foil 40 in the thickness direction of the bump foil 40. The second plate portion 81b is bent and bulges toward the top foil 30. The second plate portion 81b is not in contact with the top foil 30 when the rotary shaft 103 is not rotating. The third plate portion 81c is continuous to the second plate portion 81b and the first portion 50. The third plate portion 81c extends from the second plate portion 81b toward the beating housing 20.

The second end plate portion 82 of the bump foil 40 is disposed between the free end 42 and the second portion 60. The second end plate portion 82 is continuous to the free end 42 of the bump foil 40. The second end plate portion 82 is continuous to the second portion 60. The second end plate portion 82 has a curved portion 82a that is curved and bulges toward the bearing housing 20. The curved portion 82a is curved and has a curvature radius that is equal to the curvature radius R of the inner peripheral surface 20a of the bearing housing 20. The second end plate portion 82 is not in contact with the bearing housing 20 when the rotary shaft 103 is not rotating.

<Deformation of Top Foil and Bump Foil>

As illustrated in FIG. 2, the rotary shaft 103 rotates in a direction indicated by the arrow D when the centrifugal compressor 100 is driven. When the rotational speed of the rotary shaft 103 reaches the predetermined rotational speed, a fluid film is formed between the rotary shaft 103 and the top foil 30. The dynamic pressure of the fluid film allows the rotary shaft 103 to float off the top foil 30. The fluid film allows the rotary shaft 103 to be supported by the top foil 30 in the radial direction Rd without being in contact with the top foil 30.

The fluid film, which is formed with the rotation of the rotary shaft 103, causes the top foil 30 to become elastically deformed and bulge in the radially outward direction of the beating housing 20. The radially outward direction is the radial direction C from the axis of the bearing housing 20 toward the inner peripheral surface 20a. The second portion 60 is subjected to a load G that is applied by the top foil 30 to the second portion 60 with displacement of the top foil 30 in the radially outward direction of the bearing housing 20.

The load G increases as the rotational speed of the rotary shaft 103 increases from the predetermined rotational speed. The top foil 30 presses the second portion 60 of the bump foil 40 against the bearing housing 20 as the load G increases, so that the second bending portion 712 gradually approaches the inner peripheral surface 20a of the bearing housing 20. As the load G increases, the top foil 30 approaches the second plate portion 81b of the first end plate portion 81 and the first bending portion 711. As the load G increases, the second end plate portion 82 of the bump foil 40 approaches the inner peripheral surface 20a of the bearing housing 20.

When the load G is equal to or lower than the predetermined load Gth, the second bending portion 712 and the third extending portion 73 are not in contact with the inner peripheral surface 20a of the bearing housing 20. When the load G is equal to or lower than the predetermined load Gth, the curved portion 82a of the second end plate portion 82 is not in contact with the inner peripheral surface 20a of the bearing housing 20. When the load G is equal to or lower than the predetermined load Gth, the second plate portion 81b of the first end plate portion 81 and the first bending portion 711 are not in contact with the top foil 30.

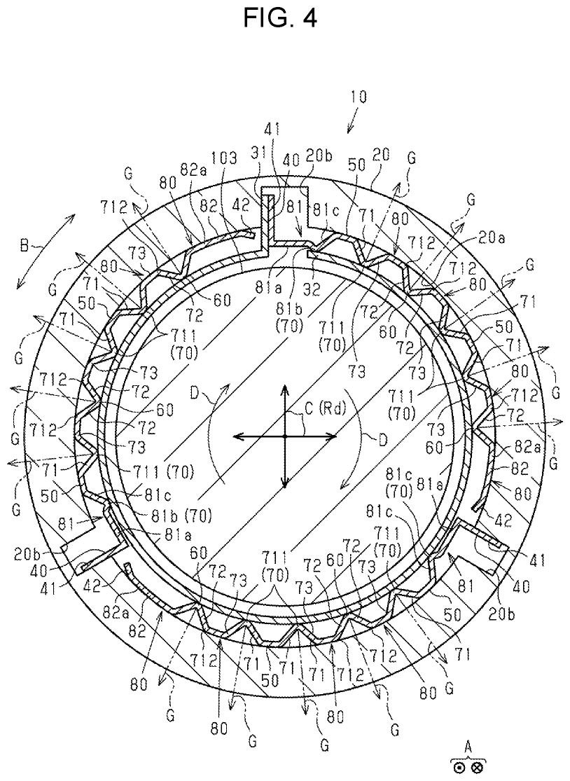

As illustrated in FIG. 4, when the load G is higher than the predetermined load Gth, the second bending portion 712 and the third extending portion 73 are in contact with the inner peripheral surface 20a of the bearing housing 20. When the load G is higher than the predetermined load Gth, the curved portion 82a of the second end plate portion 82 is in surface contact with the inner peripheral surface 20a of the bearing housing 20. When the load G is higher than the predetermined load Gth, the second plate portion 81b of the first end plate portion 81 and the first bending portion 711 are in contact with the top foil 30.

When the load G is higher than the predetermined load Gth, the second portion 60 becomes elastically deformed so as to extend in the peripheral direction B. The second portion 60 becomes elastically deformed with the displacement of the top foil 30 in the radially outward direction of the bearing housing 20. When the second portion 60 becomes elastically deformed so as to extend in the peripheral direction B, the elastic force of the second portion 60 transfers to the third extending portion 73 via the second extending portion 72. The first bending portion 711 is in contact with the top foil 30 in this situation, so that the first bending portion 711 is subjected to the load G. The third extending portion 73 is subjected to the elastic force of the second portion 60 via the second extending portion 72 and the load G via the first extending portion 71, so that the third extending portion 73 becomes elastically deformed so as to bend in the thickness direction. This causes a portion of the third extending portion 73 between the bending portion of the third extending portion 73 and the first extending portion 71 to approach the first extending portion 71. That is, the first bending portion 711 contracts in the peripheral direction B.

Furthermore, the load G presses the portion of the third extending portion 73 between the bending portion of the third extending portion 73 and the second extending portion 72 against the inner peripheral surface 20a of the bearing housing 20. Accordingly, a part of the third extending portion 73 becomes elastically deformed so as to extend along the inner peripheral surface 20a of the bearing housing 20. Therefore, the part of the third extending portion 73 is in contact with the inner peripheral surface 20a of the bearing housing 20 along the inner peripheral surface 20a when the load G is higher than the predetermined load Gth.

The second plate portion 81b and the first bending portion 711 serve as a third portion 70 that is not in contact with the top foil 30 when the load G is equal to or lower than the predetermined load Gth, and is in contact with the top foil 30 with the elastic deformation of the second portion 60 when the load G is higher than the predetermined load Gth. The bump foil 40 has the third portion 70 that is disposed at least between the first portion 50 and the second portion 60 and configured to come in contact with the top foil 30.

The second bending portion 712, the third extending portion 73, and the curved portion 82a serve as a fourth portion 80 that is not in contact with the inner peripheral surface 20a when the load G is equal to or lower than the predetermined load Gth, and is in contact with the inner peripheral surface 20a with the elastic deformation of the second portion 60 when the load G is higher than the predetermined load Gth. The bump foil 40 has the fourth portion 80 that is disposed at least between the first portion 50 and the second portion 60 and configured to come in contact with the inner peripheral surface 20a. Furthermore, a part of the third extending portion 73 is in surface contact with the inner peripheral surface 20a. Accordingly, when the load G is higher than the predetermined load Gth, the fourth portion 80 is in surface contact with the inner peripheral surface 20a.

<Relationship Between Load and Amount of Elastic Deformation of Bump Foil>

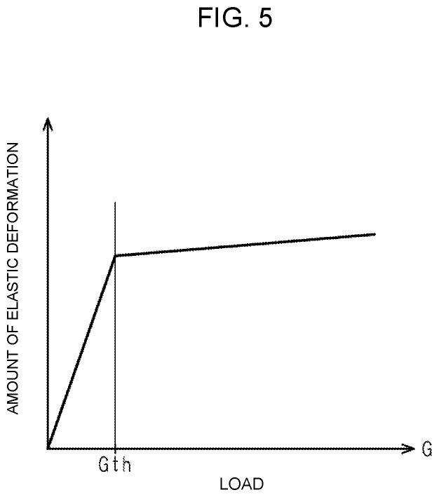

As illustrated in FIGS. 2 and 5, when the load G is equal to or lower than the predetermined load Gth, the third portion 70 is not in contact with the top foil 30. This secures the amount of the elastic deformation of the bump foil 40 when the load G is equal to or lower than the predetermined load Gth. It can be said that the amount of the elastic deformation of the bump foil 40 significantly increases with the increase of the load G when the load G is equal to or lower than the predetermined load Gth in compared with the amount of the elastic deformation of the bump foil 40 when the load G is higher than the predetermined load Gth.

As illustrated in FIGS. 4 and 5, when the load G is higher than the predetermined load Gth, the third portion 70 and the fourth portion 80 are in contact with the top foil 30 and the inner peripheral surface 20a, respectively. This increases the stiffness of the bump foil 40. The amount of the elastic deformation of the bump foil 40 when the load G is higher than the predetermined load Gth is lower than the amount of the elastic deformation of the bump foil 40 when the load G is equal to or lower than the predetermined load Gth. It can be said that the amount of the elastic deformation of the bump foil 40 gently increases with the increase of the load G when the load G is higher than the predetermined load Gth in compared with the amount of the elastic deformation of the bump foil 40 when the load G is equal to or lower than the predetermined load Gth.

FIG. 5 shows that the bump foil 40 according to the present embodiment has a property of spring which allows the stiffness of the bump foil 40 to be relatively low when the load G is equal to or lower than the predetermined load Gth and the stiffness of the bump foil 40 to be relatively high when the load G is higher than the predetermined load Gth.

[Operation of Embodiment]

The following will explain the operation according to the embodiment.

When the rotational speed of the rotary shaft 103 reaches the predetermined rotational speed, a fluid film is formed between the rotary shaft 103 and the top foil 30. The fluid film supports the rotary shaft 103 in the radial direction Rd. This configuration allows the third portion 70 of the bump foil 40 not to be in contact with the top foil 30 when the load G applied by the top foil 30 to the second portion 60 is equal to or lower than the predetermined load Gth, thereby securing the amount of the elastic deformation of the bump foil 40. This configuration therefore allows the bump foil 40 to elastically support the top foil 30. This configuration allows the third portion 70 of the bump foil 40 to be in contact with the top foil 30 when the load G applied by the top foil 30 to the second portion 60 is higher than the predetermined load Gth, thereby increasing the stiffness of the bump foil 40. This prevents excessive deformation of the bump foil 40. This therefore allows stable supporting of the rotary shaft 103 in the radial direction Rd.

The first portion 50 of the bump foil 40 is in surface contact with the inner peripheral surface 20a of the bearing housing 20. This configuration reduces deformation of the first portion 50 when the vibrating rotary shaft 103 is supported by the bump foil 40. This configuration allows the bearing housing 20 to easily support the displacing rotary shaft 103 in compared with a configuration where the first portion 50 has a spring structure, thereby facilitating damping of the vibration of the rotary shaft 103. Furthermore, the surface contact of the first portion 50 with the inner peripheral surface 20a of the bearing housing 20 facilitates securement of the contact area between the first portion 50 and the bearing housing 20. This reduces wear of the bearing housing 20 by the bump foil 40 even if the bump foil 40 is made of a material that has hardness higher than that of the material for the bearing housing 20.

### Advantageous Effect

The following will explain the advantageous effects according to the embodiment.

(1) The first portion 50 of the bump foil 40 is in surface contact with the inner peripheral surface 20a of the bearing housing 20. This configuration secures the contact area between the bump foil 40 and the bearing housing 20 while allowing the bearing housing 20 to support the vibrating rotary shaft 103. This facilitates the damping of the vibration of the rotary shaft 103 and reduces wear of the bearing housing 20 while stably supporting the rotary shaft 103 in the radial direction Rd. This therefore provides the long-life foil bearing 10.

(2) When the load G applied by the top foil 30 to the second portion 60 is higher than the predetermined load Gth, the second portion 60 and the third portion 70 are in contact with the top foil 30, and the first portion 50 and the fourth portion 80 are in contact with the inner peripheral surface 20a of the bearing housing 20. This configuration further increases the stiffness of the bump foil 40 when the load G applied by the top foil 30 to the second portion 60 is higher than the predetermined load Gth. This configuration further prevents the excessive deformation of the bump foil 40 when the load G applied by the top foil 30 to the second portion 60 is higher than the predetermined load Gth. This configuration therefore allows the rotary shaft 103 to be stably supported in the radial direction Rd when the load G applied by the top foil 30 to the second portion 60 is higher than the predetermined load Gth.

(3) When the load G applied by the top foil 30 to the second portion 60 is higher than the predetermined load Gth, the fourth portion 80, in addition to the first portion 50, is in surface contact with the inner peripheral surface 20a of the bearing housing 20. This configuration secures the contact area between the bump foil 40 and the inner peripheral surface 20a of the bearing housing 20. This configuration therefore further reduces wear of the bearing housing 20 by the bump foil 40.

(4) Facilitating the damping of the vibration of the rotary shaft 103 reduces resonance of the bearing housing 20 caused by the vibration of the rotary shaft 103.

[Modification]

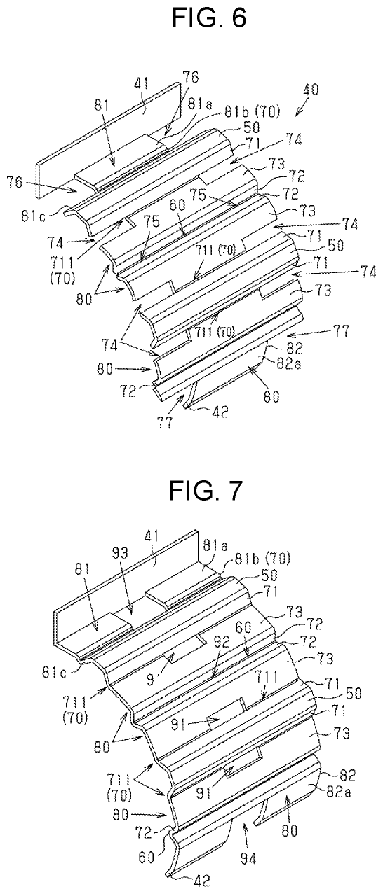

The embodiment may be modified as below. The embodiment may be combined with the following modifications within technically consistent range.
As illustrated in FIG. 6, the bump foil 40 may have a first cutout 74 and a second cutout 75. Specifically, the first cutout 74 is formed by cutting out a part of each first bending portion 711 on both sides of the first bending portion 711 in the direction of the short sides of the bump foil 40. According to the present modification, the first cutout 74 includes a cutout formed by cutting out a part of the adjacent third extending portion 73. That is, the first cutout 74 includes a cutout formed by cutting out a part of the third extending portion 73 that forms the first bending portion 711 in the direction of the long sides of the bump foil 40. Accordingly, the first cutout 74 serves a cutout that is formed by cutting out a part of the third portion 70 between the first portion 50 and the second portion 60.

The first bending portion 711 is shorter than the longest part of the third extending portion 73 in the direction of the short sides of the bump foil 40 due to the presence of the first cutout 74. The amount of the cutout of the third extending portion 73 to form the first cutout 74 is determined by considering that the contact area is sufficiently secured by the surface contact between the part of the third extending portion 73 and the inner peripheral surface 20a of the bearing housing 20 when the load G is higher than the predetermined load Gth.

The second cutout 75 is formed by cutting out a part of each second portion 60 on both sides of the second portion 60 in the direction of the short sides of the bump foil 40. The second portion 60 is shorter than the longest part of the third extending portion 73 in the direction of the short sides of the bump foil 40 due to the presence of the second cutout 75.

The bump foil 40 may have a third cutout 76 and a fourth cutout 77. The third cutout 76 is formed by cutting out a part of the first end plate portion 81 on both sides of the first end plate portion 81 in the direction of the short sides of the bump foil 40. Specifically, the third cutout 76 includes a cutout formed by cutting out a part of the second plate portion 81b of the first end plate portion 81. The first end plate portion 81 is shorter than the first portion 50 in the direction of the short sides of the bump foil 40 due to the presence of the third cutout 76.

The fourth cutout 77 is formed by cutting out a part of the second end plate portion 82 on both sides of the second end plate portion 82 and a part of the free end 42 on both sides of the free end 42 in the direction of the short sides of the bump foil 40. The second end plate portion 82 is shorter than the longest part of the third extending portion 73 in the direction of the short sides of the bump foil 40 due to the presence of the fourth cutout 77. The length of the free end 42 is equal to the length of the second end plate portion 82 in the direction of the short sides of the bump foil 40.

According to this modification, the presence of the first cutout 74 allows the stiffness of the first bending portion 711 to be lower than the stiffness of the third extending portion 73. Accordingly, the first bending portion 711 becomes more easily deformed than the third extending portion 73. This configuration prevents the deformation of the third extending portion 73 when the load G applied by the top foil 30 to the second portion 60 is higher than the predetermined load Gth. This configuration therefore prevents reduction of the contact area between the bearing housing 20 and the fourth portion 80 between the first portion 50 and the second portion 60, thereby having an inhibitory effect on wear of the bearing housing 20.

The presence of the second cutout 75 further facilitates the elastic deformation of the second portion 60. This facilitates the maintenance of the surface contact between the part of the third extending portion 73 and the inner peripheral surface 20a of the bearing housing 20 when the load G applied by the top foil 30 to the second portion 60 is higher than the predetermined load Gth.

The presence of the third cutout 76 further facilitates the elastic deformation of the second plate portion 81b of the first end plate portion 81. This facilitates the maintenance of the surface contact between the first portion 50 and the inner peripheral surface 20a of the beating housing 20 when the load G applied by the top foil 30 to the second portion 60 is higher than the predetermined load Gth.

The presence of the fourth cutout 77 facilitates the elastic deformation of the second end plate portion 82, thereby facilitating the pressing of the curved portion 82a against the inner peripheral surface 20a of the bearing housing 20 when the load G applied by the top foil 30 to the second portion 60 is higher than the predetermined load Gth.
According to the modification illustrated in FIG. 6, the first cutout 74 may be formed by cutting out a part of each first bending portion 711 on only one side of the first bending portion 711 in the direction of the short sides of the bump foil 40. That is, the first cutout 74 needs to be formed by cutting out a part of the first bending portion 711.
According to the modification illustrated in FIG. 6, the second cutout 75 may be formed by cutting out a part of each second portion 60 on only one side of the second portion 60 in the direction of the short sides of the bump foil 40. That is, the second cutout 75 needs to be formed by cutting out a part of the second portion 60.
According to the modification illustrated in FIG. 6, the third cutout 76 may be formed by cutting out a part of the second plate portion 81b of the first end plate portion 81 on both sides of the second plate portion 81b and a part of the third plate portion 81c of the first end plate portion 81 on both sides of the third plate portion 81c in the direction of the short sides of the bump foil 40. The third cutout 76 may be formed by cutting out a part of the second plate portion 81b of the first end plate portion 81 on only one side of the second plate portion 81b and a part of the third plate portion 81c of the first end plate portion 81 on only one side of the third plate portion 81c in the direction of the short sides of the bump foil 40.

The third cutout 76 may be formed by cutting out only a part of the second plate portion 81b of the first end plate portion 81 on both sides of the second plate portion 81b in the direction of the short sides of the bump foil 40. The third cutout 76 may be formed by cutting out a part of the second plate portion 81b of the first end plate portion 81 on only one side of the second plate portion 81b in the direction of the short sides of the bump foil 40. That is, the third cutout 76 needs to be formed at least by cutting out a part of the third portion 70 that is not between the first portion 50 and the second portion 60.
According to the modification illustrated in FIG. 6, the bump foil 40 may have at least one of the second cutout 75, the third cutout 76, and the fourth cutout 77 without having the first cutout 74. The bump foil 40 may have the first cutout 74 without having the second cutout 75, the third cutout 76, and the fourth cutout 77.
As illustrated in FIG. 7, the bump foil 40 may have a first cutout 91 and a second cutout 92. The first cutout 91 is formed by cutting out the center part of each first bending portion 711 in the direction of the short sides of the bump foil 40. According to the present modification, the first cutout 91 includes a cutout formed by cutting out a part of the adjacent third extending portion 73. That is, the first cutout 91 includes a cutout formed by cutting out a part of the third extending portion 73 that forms the first bending portion 711 in the direction of the long sides of the bump foil 40. Accordingly, the first cutout 91 serves as a cutout that is formed by cutting out a part of the third portion 70 between the first portion 50 and the second portion 60. The amount of the cutout of the third extending portion 73 to form the first cutout 91 is determined by considering that the contact area is sufficiently secured by the surface contact between the part of the third extending portion 73 and the inner peripheral surface 20a of the bearing housing 20 when the load G is higher than the predetermined load Gth.

The second cutout 92 is formed by cutting out the center part of each second portion 60 in the direction of the short sides of the bump foil 40.

The bump foil 40 may have a third cutout 93 and a fourth cutout 94. The third cutout 93 is formed by cutting out the center part of the first end plate portion 81 in the direction of the short sides of the bump foil 40. Specifically, the third cutout 93 includes a cutout formed by cutting out a part of the second plate portion 81b of the first end plate portion 81. The fourth cutout 94 is formed by cutting out the center part of the second end plate portion 82 and the center part of the free end 42 in the direction of the short sides of the bump foil 40.

According to this modification, the presence of the first cutout 91 allows the stiffness of the first bending portion 711 to be lower than the stiffness of the third extending portion 73. Accordingly, the first bending portion 711 becomes more easily deformed than the third extending portion 73. This configuration prevents the deformation of the third extending portion 73 when the load G applied by the top foil 30 to the second portion 60 is higher than the predetermined load Gth. This configuration therefore prevents reduction of the contact area between the beating housing 20 and the fourth portion 80, which is formed between the first portion 50 and the second portion 60, thereby having an inhibitory effect on wear of the bearing housing 20.

The presence of the second cutout 92 further facilitates the elastic deformation of the second portion 60. This facilitates the maintenance of the surface contact between the part of the third extending portion 73 and the inner peripheral surface 20a of the bearing housing 20 when the load G applied by the top foil 30 to the second portion 60 is higher than the predetermined load Gth.

The presence of the third cutout 93 further facilitates the elastic deformation of the second plate portion 81b of the first end plate portion 81. This facilitates the maintenance of the surface contact between the first portion 50 and the inner peripheral surface 20a of the bearing housing 20 when the load G applied by the top foil 30 to the second portion 60 is higher than the predetermined load Gth.

The presence of the fourth cutout 94 facilitates the elastic deformation of the second end plate portion 82, thereby facilitating the pressing of the curved portion 82a against the inner peripheral surface 20a of the bearing housing 20 when the load G applied by the top foil 30 to the second portion 60 is higher than the predetermined load Gth.
According to the modification illustrated in FIG. 7, the third cutout 93 may be formed by cutting out the center part of the second plate portion 81b of the first end plate portion 81 and the center part of the third plate portion 81c of the first end plate portion 81 in the direction of the short sides of the bump foil 40. The third cutout 93 may be formed by cutting out only the center part of the second plate portion 81b of the first end plate portion 81 in the direction of the short sides of the bump foil 40. That is, the third cutout 93 needs to be formed at least by cutting out a part of the third portion 70 that is not between the first portion 50 and the second portion 60.
According to the modification illustrated in FIG. 7, the bump foil 40 may have at least one of the second cutout 92, the third cutout 93, and the fourth cutout 94 without having the first cutout 91. The bump foil 40 may have the first cutout 91 without having the second cutout 92, the third cutout 93, and the fourth cutout 94.
The part of the third extending portion 73 may not be in contact with the inner peripheral surface 20a of the bearing housing 20 when the load G applied by the top foil 30 to the second portion 60 is higher than the predetermined load Gth. In this case, the first bending portion 711 and the second bending portion 712 need to be in contact with the top foil 30 and the inner peripheral surface 20a of the bearing housing 20, respectively. That is, the fourth portion 80 needs to be in contact with the inner peripheral surface 20a of the bearing housing 20 when the load G applied by the top foil 30 to the second portion 60 is higher than the predetermined load Gth. The third extending portion 73 may have a flat plate shape.
The second bending portion 712 may not be in contact with the inner peripheral surface 20a of the bearing housing 20 when the load G applied by the top foil 30 to the second portion 60 is higher than the predetermined load Gth. The fourth portion 80 may not be in contact with the inner peripheral surface 20a of the bearing housing 20 when the load G applied by the top foil 30 to the second portion 60 is higher than the predetermined load Gth.
In each bump foil 40, the number of the first portions 50 and the number of the second portions 60 may be changed as necessary.
The foil bearing 10 according to the present embodiment includes the three bump foils 40, but the foil bearing 10 may include a single bump foil 40 having an approximately cylindrical shape. In this configuration, the bearing housing 20 may have a single holding groove 20b. The number of the first portions 50 and the number of the second portions 60 need to be determined such that the bump foil 40 can elastically support the top foil 30 appropriately.
In the first end plate portion 81 of the bump foil 40, the first plate portion 81a may be continuous to the third plate portion 81c without the second plate portion 81b.
The bump foil 40 may not have the second end plate portion 82.
The foil bearing 10 is not limited to a foil bearing that supports the rotary shaft 103 of the centrifugal compressor 100 in the radial direction Rd. Objects to which the foil bearing 10 is applicable may be changed as necessary.

What is claimed is:

1. A foil bearing, which supports a rotary shaft in a radial direction of the rotary shaft, comprising:
a bearing housing having a cylindrical shape and through which the rotary shaft is inserted;
a top foil having a thin plate shape and disposed between the rotary shaft and the beating housing; and
a bump foil having a thin plate shape and made of a material that has hardness higher than hardness of a material for the bearing housing, the bump foil being disposed between the beating housing and the top foil to elastically support the top foil, wherein
the bump foil has:
a first portion in contact with an inner peripheral surface of the bearing housing;
a second portion in contact with the top foil and configured to become elastically deformed with displacement of the top foil in a radially outward direction of the bearing housing; and
a third portion disposed at least between the first portion and the second portion and configured to come in contact with the top foil,
the top foil applies a load to the second portion with the displacement of the top foil in the radially outward direction of the bearing housing,
the third portion is not in contact with the top foil when the load is equal to or lower than a predetermined load, and is in contact with the top foil with elastic deformation of the second portion when the load is higher than the predetermined load, and
the first portion is in surface contact with the inner peripheral surface.

2. The foil bearing according to claim 1, wherein
the bump foil has a fourth portion that is disposed at least between the first portion and the second portion and configured to come in contact with the inner peripheral surface, and
the fourth portion is not in contact with the inner peripheral surface when the load is equal to or lower than the predetermined load, and is in contact with the inner peripheral surface with the elastic deformation of the second portion when the load is higher than the predetermined load.

3. The foil bearing according to claim 2, wherein
the fourth portion is in surface contact with the inner peripheral surface when the load is higher than the predetermined load.

4. The foil bearing according to claim 2, wherein
the bump foil has a uniform thickness, and
the bump foil has a cutout that is formed by cutting out a part of the third portion between the first portion and the second portion.
